(19) United States
(12) Patent Application Publication
(10) Pub. No.: US 2004/0126288 A1
(43) Pub. Date: Jul. 1, 2004

(54) Hydrogen generator for fuel cell

(76) Inventors: Akira Fuju, Osaka (JP); Osamu Tajima, Osaka (JP); Fusao Terada, Osaka (JP)

Correspondence Address: MCDERMOTT, WILL & EMERY, 600 13th Street, N.W., Washington, DC, 20005-3096, US

(21) Appl. No.: 10/715,841

(22) Filed: Nov. 19, 2003

(30) Foreign Application Priority Data
Nov. 21, 2002 (JP) 2002-337929

(51) Int. Cl. B01J 8/02; H01M 8/06

(52) U.S. Cl. 422/202; 429/19; 429/20; 422/211

(57) ABSTRACT

To provide a hydrogen generator for a fuel cell for generating a hydrogen-rich gas by steam reforming a source of hydrocarbon fuel gas and supplying the hydrogen-rich gas to a fuel cell or the like to make it possible to efficiently heat a reforming catalyst in a reforming pipe by a combustion gas. A reforming pipe in which a reforming pipe is formed by filling a reforming catalyst between an erect pipe and a polygonal or wavelike outer pipe surrounding the erect pipe and an outermost pipe in which vertexes of the polygonal or wavelike outer pipe are inscribed to the contour of the reforming pipe are set to form a route of a reformed gas between the outer pipe and the outermost pipe. It is preferable to concentrically arrange a combustion pipe, the reforming pipe, the outermost pipe, the heat insulating means, a CO transformer, a first spatial portion, a CO eliminator, a second spatial portion, and a vessel in order.

### BACKGROUND OF THE INVENTION

1. Field of the Invention

The present invention relates to a hydrogen generator for a fuel cell, more particularly to a hydrogen generator for a fuel cell for generating a hydrogen-rich gas by steam reforming a source of hydrocarbon fuel gas such as city gas and supplying the generated hydrogen-rich gas to the fuel cell or the like.

2. Detailed Description of the Related Art

A system is conventionally known in which a source of hydrocarbon fuel gas such as city gas is steam reformed to generate a hydrogen-rich gas and a chemical energy of the obtained hydrogen-rich gas is directly converted into electric energy by a fuel cell.

A fuel cell uses hydrogen and oxygen as fuel. To generate hydrogen, a method is widely used in which a hydrocarbon component such as natural gas, alcohol such as methanol, or an organic compound having hydrogen atoms in a molecule such as naphtha are reformed with steam. The reforming reaction using steam is an endothermic reaction. Therefore, it is necessary to raise the temperature of a hydrogen generator for performing steam reforming by heating a raw material, steam, and reforming catalyst for performing a reforming reaction. With considering hydrogen generation efficiency, it is desirable to minimize the heat quantity consumed during the above reaction.

The reaction for reforming the organic compound such as naphtha with steam generates not only hydrogen and carbon dioxide but also a by-product such as carbon monoxide. In the case of a molten carbonate fuel cell such as high-temperature type, carbon monoxide by-produced at the time of steam reforming can be also used as fuel. However, in the case of a low phosphoric acid fuel cell to be operated at a low temperature, a sufficient power generation characteristic cannot be obtained because of poisoning of a platinum-based catalyst used as a sell electrode by carbon monoxide. Therefore, the hydrogen generator used for the fuel cell having the low operating temperature is provided with a CO transformer for making carbon monoxide contained in a reformed gas react with water. Moreover, a solid polymer type electrolyte fuel cell to be operated at a lower temperature than that of phosphoric acid fuel cell is further provided with a CO eliminator for selectively oxidizing carbon monoxide to reduce it.

As described above, when generating hydrogen by reforming the raw material such as naphtha as the fuel for the solid oxide electrolyte fuel cell having the low operating temperature, the following reactions are necessary: the steam reforming reaction of the organic compound, the transformation reaction of carbon monoxide, and the selective oxidation reaction of carbon monoxide.

Because the reactions in the above processes are greatly different from each other in reaction temperatures, it is important to control them so that each reactor is kept at a proper temperature. It is necessary to maintain the steam reforming reaction at the highest temperature among those reactions and then successively the carbon-monoxide transformation and the carbon-monoxide selective oxidation reaction at a lower temperature in order. Moreover, to raise the operating efficiency of the hydrogen generator, it is desirable to recover excess heat of each reactor and control temperature.

FIG. 6 shows a conventional hydrogen generator for a fuel cell (for example, refer to Patent Document 1). A conventional hydrogen generator for a fuel cell 30 is provided with a reforming pipe 32 having a reforming catalyst 31 for making a source of hydrocarbon fuel gas react with water and reforming them into a hydrogen-rich gas, a fuel supplying part 33 for supplying a fuel gas to the reforming pipe 32, a water supplying part 34 for supplying water to the reforming pipe 32, a heating means 36 for supplying a heat quantity necessary for a reforming reaction by burning a combustion fuel in a combustion pipe 35, a CO transformer 37 for making carbon monoxide contained in the reformed gas exhausted from he reforming pipe 32 react with water and transforming them into carbon dioxide, and a not-illustrated CO eliminator having a selective oxidation catalyst for making carbon monoxide contained in the transformed gas flowing out from the CO transformer 37 react with air or oxygen to produce carbon dioxide.

The source of hydrocarbon fuel gas is added with steam and then sent to the reforming pipe 32 from the fuel supplying part 33. Steam is generated as water such as cooling water circulating through a system is preheated by, for example, the heating means 36 and heat-exchanged with exhaust heat of a fuel cell system to generate steam. The fuel gas added with steam contacts with the reforming catalyst 31 of the reforming pipe 32 and is steam reformed into a hydrogen-rich gas by a catalytic reaction (endothermic reaction at approximately 700° C.). Because the Generated hydrogen-rich gas contains carbon monoxide, it reacts with extra steam (exothermic reaction at approximately 200 to 300° C.) in the CO transformer 37 to transform carbon monoxide into carbon dioxide. The carbon monoxide still contained in the transformed gas flowing out from the CO transformer 37 is made to contact with the selective oxidation catalyst in a not-illustrated CO eliminator and react with air or oxygen (exothermic reaction at approximately 100 to 200° C.) to transform the carbon monoxide into carbon dioxide and thus to produce a hydrogen-rich gas having a low carbon-monoxide concentration.

The hydrogen-rich gas obtained as described above is continuously supplied to a hydrogen electrode 39a of a fuel cell 39 to cause a cell reaction with the air supplied to an air electrode 39b and to generate power.

The heating means 36 constituted by a burner 40 for burning a combustion fuel such as a fuel gas or unreacted hydrogen gas exhausted from the fuel cell 39 is attached to the hydrogen generator for the fuel cell 30 to provide the heat quantity necessary for the reforming reaction in the reforming pipe 32 by burning the fuel gas or unreacted hydrogen gas in the combustion pipe 36 and raise the temperature of the reforming catalyst 31 to promote catalytic action.

As shown in FIG. 6, the reform system for the fuel cell is proposed in which a CO transformer is not externally set but the CO transformer is set along the outer circumference of the wall surface of a reformer and a heat exchanger is set to the outlet of the reformer so as to control the temperature of a reformed gas entering the CO transformer (for example, refer to the Patent Document 2).

[Paten Document 1]

Japanese Patent Laid-Open No. 2000-281313

[Patent Document 2]

Japanese Patent No. 3108269

In the case of a conventional fuel cell hydrogen generator, there is a reformed gas outlet at the outer circumferential side of the reforming pipe 32 of a cylindrical double pipe, exhaust gas passages through which exhaust gas passes are set at both of the inside and outside of the reforming pipe 32, and the reforming catalyst 31 in the reforming pipe 32 is heated by the exhaust gas flowing through the inside and the exhaust gas flowing through the outside. However, this configuration has a problem that the efficiency is deteriorated because the reforming catalyst is cooled with heat of the reforming catalyst 31 being taken by the reformed gas passing through the reformed gas outlet route and moreover, heating by the exhaust gas flowing through the outside of the reforming pipe 32 is performed through the reformed gas outlet route. Furthermore, the configuration has a problem that maneuvering of piping is necessary, a system configuration becomes complex to increase the cost, a heat loss is generated, and efficiency lowers because reactors such as a CO transformer and a CO eliminator are set separately from a reformer (they are externally set) in order to individually control those different from each other in temperature level.

Furthermore, the conventional reform system for fuel cell in which the CO transformer is set along the outer circumference of the wall surface of the reformer and the heat exchanger is set at the outlet of the reformer so as to control the temperature of the reformed gas entering the CO transformer has a problem that its structure is increased in size because the heat exchanger is necessary.

### SUMMARY OF THE INVENTION

It is the first object of the present invention to provide a hydrogen generator for a fuel cell making it possible to solve conventional problems relating to a hydrogen generator for a fuel cell for generating a hydrogen-rich gas by steam reforming a source of hydrocarbon fuel gas and supplying the gas to a fuel cell or the like and efficiently perform heating by the exhaust gas of a reforming catalyst in a reforming pipe. It is the second object of the present invention to provide the hydrogen generator for the fuel cell achieving the first object and moreover, disusing a heat exchanger externally set to the outlet of a reformer by uniting the reformer, the CO transformer, and the CO eliminator greatly different from each other in reaction temperature, and capable of accurately controlling each reactor at an optimum temperature by recovering and effectively using excess heat of each reactor, having a high heat efficiency, a simple structure, and capable of being downsized.

To solve the above problems, the hydrogen generator for the fuel cell of claim 1 comprises; a reforming pipe comprising; an erect inner pipe; an outer pipe surrounding said erect inner pipe of which cross section is polygonal or wavelike; and a catalyst layer formed between the erect inner pipe and the outer pipe, with said catalytic layer being filled with a reforming catalyst to make a fuel containing an organic compound having hydrogen atoms react with water to reform into a hydrogen-rich gas;

an outermost pipe surrounding and inscribed by the outer pipe in each vertexes of the contour thereof; and

a passage of the reformed gas formed between the outer pipe and the outermost pipe.

For example, by setting a combustion pipe at the inside of the reforming pipe, burning a combustion fuel in the combustion pipe and thereby supplying heat quantity necessary for a reforming reaction to a catalyst layer, making a reformed gas pass through a passage of the reformed gas formed between the outer pipe and the outermost pipe while supplying exhaust gas to the inside of an inner pipe of the reforming pipe and the outer circumference of the outermost pipe, vertexes of the polygonal or wavelike outer pipe are inscribed to the outermost pipe. Therefore, the heat of the exhaust gas is conducted to the outer pipe side of the reforming pipe from the outermost pipe through the contact points or contact faces, the reforming catalyst in the reforming pipe is heated by exhaust gas from the inside of the inner pipe and also heated by exhaust gas from the outer pipe side. Thus, it is possible to restrain the heat lost by the reformed gas and improve the heating efficiency.

The hydrogen generator for the fuel cell of claim 2 uses the hydrogen generator for the fuel cell of claim 1, further comprising; a fuel supplying part for supplying the fuel to the reforming pipe; a water supplying part for supplying the water to the reforming pipe; a heating means for supplying a heat quantity necessary for a reforming reaction by burning a combustion fuel in a combustion pipe set inside of the erect inner pipe of the reforming pipe; a heat insulating means for insulating the heat released from the reforming pipe at the outer periphery of the outermost pipe; a CO transformer for making carbon monoxide contained in a reformed gas flowing out from the reforming pipe react with water and thereby to transform carbon monoxide and water into carbon dioxide; a CO eliminator having an selective oxidation catalyst for making carbon monoxide contained in a transformed gas flowing out from the CO transformer react with air or oxygen to generate carbon dioxide; and a vessel for housing the above components, wherein the combustion pipe, the reforming pipe, the outermost pipe, the heat insulating means, the CO transformer, a first spatial portion, the CO eliminator, a second spatial portion, and the vessel are arranged in a concentrical circular way in order from the inside.

The hydrogen generator for the fuel cell of claim 2 of the present invention has the same advantages as the hydrogen generator for the fuel cell of claim 1 and moreover, it has a simple configuration and is able to be downsized and able to accurately control each reactor at an optimum temperature by recovering and effectively using the excess heat of each reactor and thus, realizes a high heat efficiency because of setting the combustion pipe of the heating means for supplying the heat quantity necessary for the reforming reaction by burning a combustion fuel at the center, setting the reforming pipe around the combustion pipe, the outermost pipe around the reforming pipe, and the heat insulating means at the outside of the outermost pipe, setting the CO transformer at the outside of the outermost pipe, setting the CO eliminator at the outside of the CO transformer, concentrically housing the above components in one vessel and uniting them into one body, and disusing the heat exchanger at the outlet of the reformer.

The hydrogen generator for the fuel cell of claim 3 of the present invention uses the hydrogen generator for the fuel cell of claim 2, wherein the heat insulating means is a heat insulting material, and a quality and a thickness of the heat insulating material are selected so as to be able to control the surface temperature of the heat insulating material at 200 to 300° C.

By controlling the surface temperature of the heat insulating material at 200 to 300° C., it is possible to accurately control the reaction temperature of the CO transformer at the optimum temperature of 200 to 300° C.

The hydrogen generator for the fuel cell of claim 4 of the present invention uses the hydrogen generator for the fuel cell of claim 2 or clam 3, wherein the heat insulating means is a mirror-surface heat insulating member and a quality, a thickness, and a surface finish state of the mirror-surface heat insulating member are selected so as to be able to control the inside temperature of the CO transformer at 200 to 300° C.

When selecting the material, thickness, and surface finish state of the mirror-surface heat insulating member so as to be able to control the inside temperature of the CO transformer at 200 to 300° C., it is possible to accurately control the reaction temperature of the CO transformer at the optimum temperature of 200 to 300° C. and further downsize the hydrogen generator for the fuel cell by using the mirror-surface heat insulting member together with a heat insulating material.

The hydrogen generator for the fuel cell of claim 5 of the present invention uses the hydrogen generator for the fuel cell of claim 2, wherein the heat insulating means is a vacuum space and a thickness and a vacuum degree are selected so as to be able to control the inside temperature of the CO transformer at 200 to 300° C.

When selecting the thickness and vacuum degree of the vacuum space so as to be able to control the inside temperature of the CO transformer at 200 to 300° C., it is possible to accurately control the reaction temperature of the CO transformer at the optimum temperature of about 200 to 300° C. and further downsize the hydrogen generator for the fuel cell by using the generator together with the heat insulating material and the mirror-surface heat insulating member.

The hydrogen generator for the fuel cell of claim 6 of the present invention uses any one of the hydrogen generator for the fuel cells of claims 2 to 5, wherein a heat-transfer acceleration material or heat storing material is set to the reformer outlet.

Because the temperature nearby the outlet of the reformer reaches approximately 200 to 300° C. under operating conditions of the hydrogen generator for the fuel cell of the present invention, the temperature of the heat transfer accelerating material or the heat storing material (reticulate or granular alumina or stainless steel) set to the outlet of the reformer also becomes approximately 200 to 300° C. Therefore, it is possible to keep the temperature of the reformed gas contacting with the heat transfer accelerating material or the heat storing material at approximately 200 to 300° C. and accurately control the reaction temperature in the CO transformer at the optimum temperature by recovering and effectively using excess heat.

The hydrogen generator for the fuel cell of claim 7 of the present invention uses the hydrogen generator for the fuel cell of any one of claims 2 to 6, wherein the external wall of the vessel is sloped in the range from the transformed-gas inlet up to the transformed-gas outlet of the CO eliminator to change the quantity of the selective oxidation catalyst across the diameter from the inlet up to the transformed gas outlet.

For example, by decreasing the quantity of the selective oxidation catalyst at the transformed gas inlet of the CO eliminator and increasing the quantity of the selective oxidation catalyst toward the transformed gas outlet, it is possible to decrease the calorific value due to the exothermic reaction nearby the transformed gas inlet of the CO eliminator, prevent a runway reaction from occurring, and accurately control the reaction temperature in the CO eliminator at the optimum temperature (approximately 100 to 200° C.).

The hydrogen generator for the fuel cell of claim 8 of the present invention uses the hydrogen generator for the fuel cell of any one of claims 2 to 7, wherein a blower is set in the vessel to control temperature by supplying air to the first spatial portion and second spatial portion.

By supplying air to the first spatial portion and the second spatial portion to control temperature, it is possible to cool the heat due to exothermic reactions in the CO transformer and CO eliminator and accurately control the CO transformer and CO eliminator at an optimum temperature.

The hydrogen generator for the fuel cell of claim 9 of the present invention uses the hydrogen generator for the fuel cell of any one of claims 2 to 8, wherein a blower is set in the vessel to control the temperature of the selective oxidation catalyst layer at the transformed gas inlet of the CO eliminator at 100 to 200° C.

It is possible to decrease the calorific value due to the exothermic reaction nearby the transformed gas inlet of the CO eliminator.

### BRIEF DESCRIPTION OF THE DRAWINGS

FIG. 1 is a cross-sectional explanatory view showing an embodiment of hydrogen generator for a fuel cell of the present invention;

FIG. 2(a) is an explanatory view showing an embodiment of the cross section of the hydrogen generator for the fuel cell of the present invention shown in FIG. 1, taken along the line A-A in FIG. 1, and FIG. 2(b) is an explanatory view showing another embodiment of the cross section of the hydrogen generator for the fuel cell of the present invention shown in FIG. 1, taken along the line A-A in FIG. 1;

FIG. 3 is a cross-sectional explanatory view showing another embodiment of the hydrogen generator for the fuel cell of the present invention;

FIG. 4 is a cross-sectional explanatory view showing another embodiment of the hydrogen generator for the fuel cell of the present invention;

FIG. 5 is a cross-sectional explanatory view showing another embodiment of the hydrogen generator for the fuel cell of the present invention; and

FIG. 6 is a cross-sectional explanatory view showing a conventional fuel cell hydrogen generator.

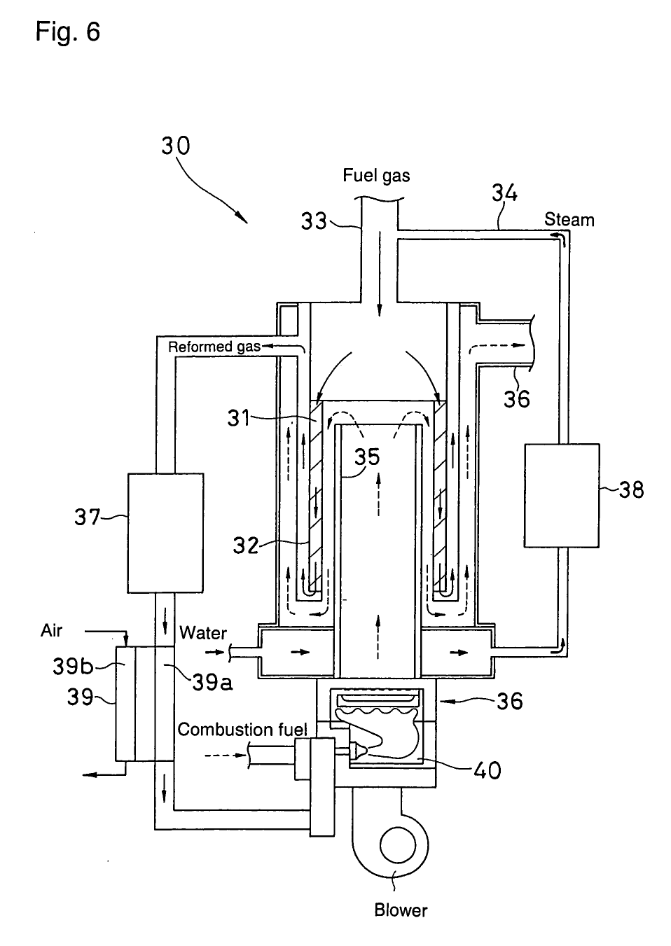

### DETAILED DESCRIPTION OF THE PREFERRED EMBODIMENT

Embodiments of the present invention are described below in detail by referring to the accompanying drawings.

(1) First Embodiment

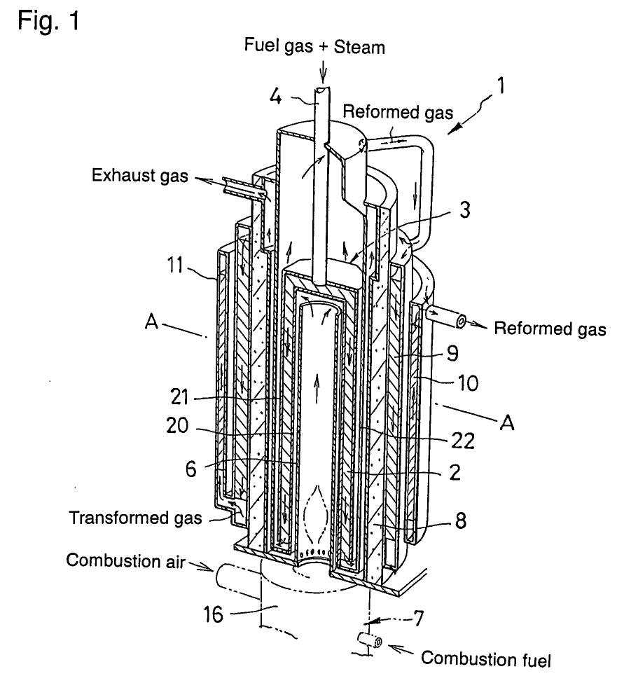

FIG. 1 is a cross-sectional explanatory view showing an embodiment of hydrogen generator for a fuel cell of the present invention.

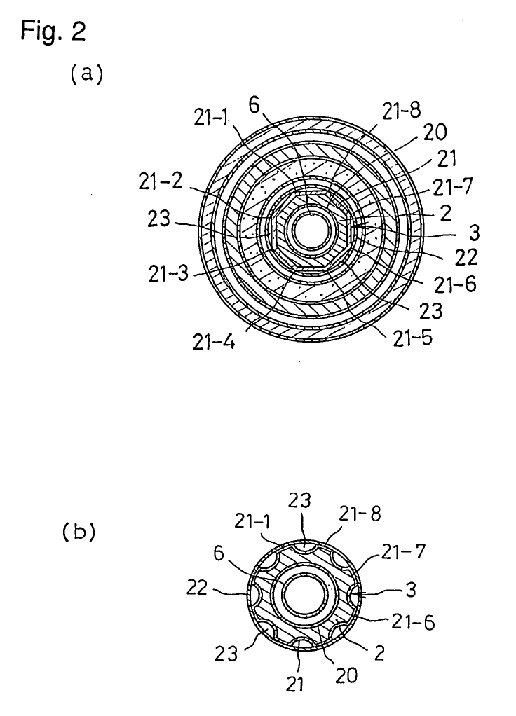

FIG. 2(a) is an explanatory view showing an embodiment of the cross section of the hydrogen generator for the fuel cell of the present invention shown in FIG. 1, taken along the line A-A in FIG. 1, and FIG. 2(b) is an explanatory view showing another embodiment of the cross section of the hydrogen generator for the fuel cell of the present invention shown in FIG. 1, taken along the line A-A in FIG. 1.

The hydrogen generator for the fuel cell 1 of the present invention is provided with a reforming pipe 3 in which a catalyst layer 2 is formed by packing a reforming catalyst for making a fuel containing an organic compound having hydrogen atoms in molecules react with water and reforming the compound and water into a hydrogen-rich gas between an erect inner pipe 20 and a polygonal outer pipe 21 surrounding the erect inner pipe 20, and provided with as shown in FIG. 2(a), an outermost pipe 22 in whose contour vertexes 21-1 to 21-8 of the polygonal outer pipe 21 are inscribed, and eight reformed gas routes 23 are formed between the outer pipe 21 and the outermost pipe 22. In another embodiment as shown in FIG. 2(b), it is provided with an outermost pipe 22 in whose contour vertexes 21-1 to 21-8 of a wavelike outer pipe 21 are inscribed (contact area is larger than the case of FIG. 2(a)) and also in the case of this example, eight reformed gas routes 23 are formed between the outer pipe 21 and the outermost pipe 22. The numeral 7 denotes heating means, 8 denotes a heat insulating material for insulating the heat radiated from the reforming pipe 3, 9 denotes a CO transformer, 10 denotes a selective oxidation catalyst, 11 denotes a CO eliminator, and 16 denotes a burner.

Moreover, the hydrogen generator for the fuel cell 1 of the present invention is constituted by setting a combustion pipe 6 to the inside of the inner pipe 20 of the reforming pipe 3 so as to supply a heat quantity necessary for a reforming reaction through combustion of a combustion fuel in the combustion pipe 6 to the catalyst layer 2, making a reformed gas pass through eight reformed gas routes 23 formed between the outer pipe 21 and outermost pipe 22 while exhaust gas passes downward between the inner pipe 20 and combustion pipe 6 and then it is supplied to the outer circumference of the outermost pipe 22.

A combustion gas such as a hydrocarbon-based gas is added with steam and then sent from a fuel supply portion 4 to the reforming pipe 3. The fuel gas added with steam is steam reformed into a hydrogen-rich gas through a catalyst reaction (endothermic reaction at approximately 700° C.) by contacting with the catalyst layer 2 of the reforming pipe 3.

Because vertexes 21-1 to 21-8 of the polygonal outer pipe 21 are inscribed in the outermost pipe 22, the heat of exhaust gas is conducted from the outermost pipe 22 to the outer pipe 21 of the reforming pipe 3 through the contact points and the reforming catalyst 2 in the reforming pipe 3 is heated by exhaust gas from the inside of the inner pipe 20 and moreover heated by exhaust gas from the outer pipe 21. Therefore, it is possible to prevent heat from being taken by a reformed gas and thus, the heating efficiency is improved.

(2) Second Embodiment

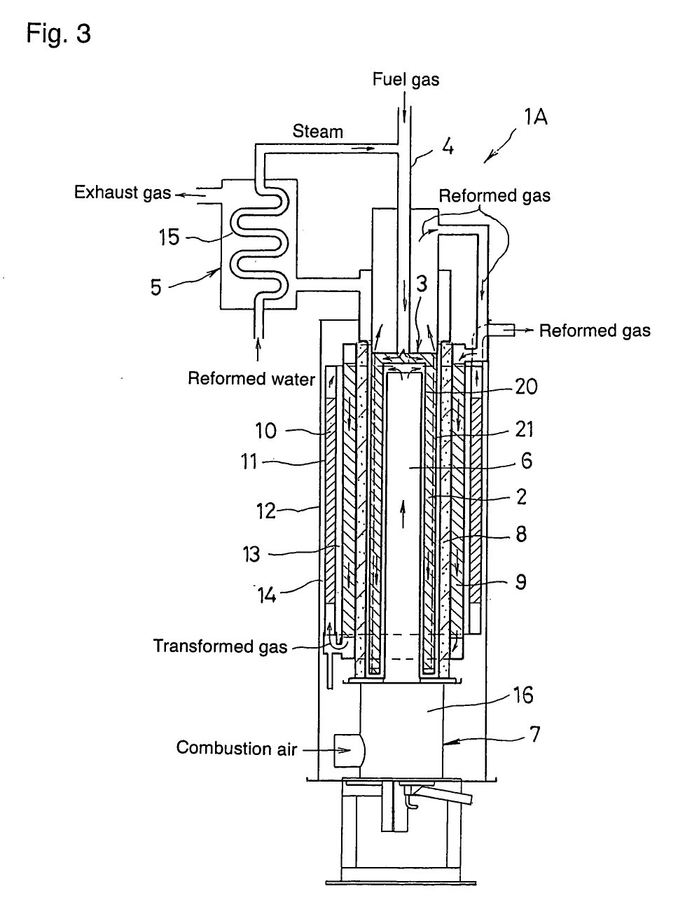

FIG. 3 is a cross-sectional explanatory view showing another embodiment of the hydrogen generator for the fuel cell of the present invention.

In FIG. 3, components provided with numerals same as those shown in FIGS. 1 and 2 show the same components shown in FIGS. 1 and 2 but duplicate explanation is omitted.

In the case of a reforming pipe 3 of hydrogen generator for a fuel cell 1A of the present invention, a catalyst layer 2 is formed by packing a reforming catalyst between an inner pipe 20 and a polygonal outer pipe 21 surrounding the inner pipe 20 the same as the case of the hydrogen generator for the fuel cell 1 of the present invention sown FIGS. 1 and 2 and, a not-illustrated outermost pipe 22 in whose contour vertexes 21-1 to 21-8 of the polygonal or wavelike outer pipe 21 are inscribed is set.

As shown in FIG. 3, the hydrogen generator for the fuel cell 1A of the present invention comprises a reforming pipe 3 in which a catalyst layer 2 is formed by packing a reforming catalyst for making a fuel containing an organic compound having hydrogen atoms in molecules react with water to reform the compound and water into a hydrogen-rich gas, a fuel supply pipe 4 for supplying a fuel gas to the reforming pipe 3, a water supply portion 5 for supplying water to the reforming pipe 3, heating means 7 for supplying heat necessary for a reforming reaction by burning a combustion fuel in a combustion pipe 6, a heat insulating material 8 for insulating the heat radiated from the reforming pipe 3, a CO transformer 9 for making carbon monoxide contained in the reformed gas exhausted from the reforming pipe 3 react with water to transform into carbon dioxide, a CO eliminator 11 having a selective oxidation catalyst 10 for making the carbon monoxide contained in the transformed gas exhausted from the CO transformer 9 react with air or oxygen to transform into carbon dioxide, and a vessel 12 for housing these components, in which the combustion pipe 6, the reformation pie 3, the outermost pipe 22, the heat insulating material 8, the CO transformer 9, a first spatial portion 13, the CO eliminator 11, a second spatial portion 14, and the vessel 12 are concentrically arranged in this order from the inside.

A fuel gas such as a source hydrocarbon-based gas is added with steam and then sent from the fuel supply portion 4 to the reforming pipe 3. The steam is generated by a steam generator 15 when water such as the cooling water circulating through a system is heat-exchanged with the exhaust heat of the exhaust gas after burning a combustion fuel in the combustion pipe 6. The fuel gas added with the steam contacts with the catalyst layer 2 of the reforming pipe 3 and thereby it is steam reformed into a hydrogen-rich gas in accordance with a catalyst reaction (endothermic reaction at approximately 700° C.). Because the generated hydrogen-rich gas contains carbon monoxide, the carbon monoxide is transformed into carbon dioxide in accordance with a reaction (exothermic reaction at approximately 200 to 300° C.) with extra steam in the CO transformer 9. The carbon monoxide contained in the transformed gas exhausted from the CO transformer 9 is made to contact with the selective oxidation catalyst of the CO eliminator 11 and react with air or oxygen (exothermic reaction at approximately 100 to 200° C.) to generate carbon dioxide and reform the transformed gas into a hydrogen-rich gas having a low carbon-monoxide concentration.

The hydrogen-rich gas obtained as described above is continuously supplied to a hydrogen electrode of a not-illustrated fuel cell and causes a cell reaction with the air supplied to an air electrode to generate power.

The heating means 7 constituted by the burner 16 or the like for burning a combustion fuel such as a fuel gas or an unreacted hydrogen gas exhausted from a fuel cell is set to the hydrogen generator for the fuel cell 1 and a heat quantity necessary for a reforming reaction in the reforming pipe 3 is supplied by burning a combustion fuel in the combustion pipe 6 to raise the temperature of the catalyst layer 2 and accelerate the catalyst action. After the combustion fuel is burnt in the combustion pipe 6, the exhaust gas passes between the combustion pipe 6 and the reforming pipe 3 and flows downward, and then passes through an exhaust gas passage between a not-illustrated outermost pipe 22 and the heat insulating material 8 and flows upward to generate steam by heat-exchanging with reformed water in the steam generator 15 and thereafter, the exhaust gas is exhausted to the outside.

Because the catalyst layer 2 in the reforming pipe 3 is heated by the exhaust gas from the inside of the inner pipe 20 and moreover heated by the exhaust gas also from the outer pipe 21 side, it is possible to prevent heat from being taken by the exhaust gas and thereby, the heating efficiency is improved.

It is preferable that the heat insulting material 8 can insulate the heat radiated from the reforming pipe 3 and improve the heat efficiency and a quality and a thickness of the heat insulating material 8 are selected so that the surface temperature thereof is kept at a temperature almost equal to the temperature (approximately 200 to 300° C.) of the adjacent CO transformer 9. A quality of the heat insulating material 8 is accepted as long as the quality makes it possible to keep the heat insulting material 8 at 200 to 300° C. Thus, it is possible to use any one of ceramic fiber, alumina, silicon-based material such as silica, rock wool, and so on. Among these materials, powder, particles, and a molded product obtained by solidifying the powder of ceramic fiber, alumina, or silicon-based material such as silica has high heat resistance and proper heat conductivity. Therefore, it is possible to decrease the thickness of the heat insulating material 8 and in the quality of these materials the surface temperature of the heat insulating material 8 becomes 200 to 300° C. even if decreasing the thickness thereof. Therefore, it is possible to preferably use these materials for the present invention.

By controlling the surface temperature of the heat insulating material 8 at 200 to 300° C., it is possible to accurately control the reaction temperature of the CO transformer 9 at an optimum temperature of 200 to 300° C.

Moreover, as for the heat insulating means, not only by setting a heat insulating material but also by setting a mirror-surface heat insulating member whose surface is mirror-finished or by mirror-finishing the inside face of the CO transformer 9, it is possible to reflect the heat radiated from the reforming pipe 3.

Furthermore, by even vaccumizing the space from the reforming pipe to the CO transformer, it is possible to obtain a heat insulating effect.

The following shows a relation between the thickness and the external surface temperature of the heat insulating material 8 [outside air temperature: 20° C., heat conductivity of heat insulating material 8: 0.03 (W/mK)] when the surface temperature of the outer pipe 21 of the reforming pipe 3 is 700° C. and thickness of the heat insulating material 8 are changed by using silica powder and alumina-silica fiber respectively having a heat conductivity of 0.1 (W/mK) or less at 600° C. To control the surface temperature of the heat insulating material 8 at 200 to 300° C., it is found that it is preferable to set the thickness of the heat insulating material 8 to approximately 3 mm in this case.

| Thickness of heat | External surface temperature of heat |
|---|---|
| insulating material 8 (mm) | insulating material 8 (° C.) |
| 3 | 228 |
| 5 | 176 |
| 7 | 146 |
| 10 | 123 |

The optimum temperature of the CO transformer 9 approximately ranges between 200 and 300° C. as described above. However, in the case of a temperature lower than 200° C., a static reaction (exothermic reaction) for making carbon monoxide contained in a reformed gas react with water to transform them into carbon dioxide does not progress or it is slow. In the case of a temperature higher than 300° C., however, a catalyst is deteriorated and its service life is shortened.

The optimum temperature of the CO eliminator 11 approximately ranges between 100 and 200° C. as described above. In the case of a temperature lower than 100° C., a selective oxidation reaction (exothermic reaction) for making carbon monoxide contained in a transformed gas react with oxygen or air to transform them into carbon dioxide does not progress or it is slow.

However, in the case of a temperature higher than 200° C., a difficulty occurs that a runaway reaction occurs and hydrogen is consumed and moreover, a catalyst is deteriorated and its service life may be shortened.

CO+3H₂→H₂O

C02+4H₂→CH₄+2H₂O

The first spatial portion 13 is formed between the CO transformer 9 and the CO eliminator 11, and the second spatial portion 14 is formed between the CO eliminator 11 and the vessel 12. It is preferable that a not-illustrated blower is set in the vessel 12 to which cooling air is supplied, and the air is sent to the first spatial portion 13 and the second spatial portion 14 to cool the CO transformer 9 and the CO eliminator 11 and to control temperature thereof so as to be kept respectively at an optimum temperature. By controlling temperature as described above, it is possible to eliminate the heat caused by exothermic reactions in the CO transformer 9 and the CO eliminator 11 and accurately control them at an optimum temperature respectively.

(3) Third Embodiment

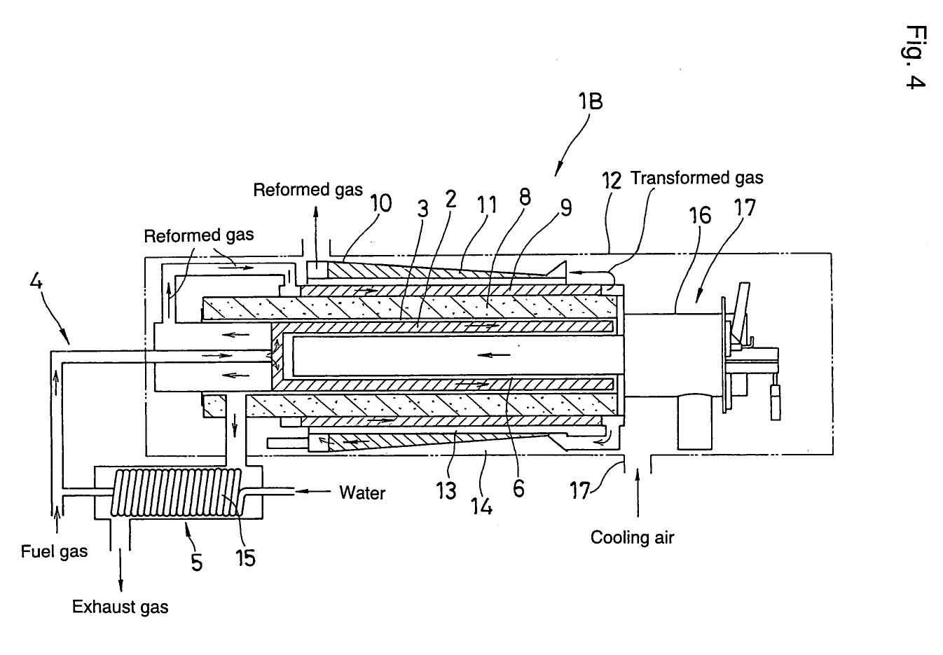

FIG. 4 is a cross-sectional explanatory view showing another embodiment of the hydrogen generator for the fuel cell of the present invention.

In FIG. 4, components provided with numerals same as those shown in FIGS. 1 to 3 show the same components shown in FIGS. 1 to 3 but duplicate explanation is omitted.

As shown in FIG. 4, a CO eliminator 11 of hydrogen generator for a fuel cell 1B of the present invention, a gradient is formed on the external wall of the vessel of the CO eliminator 11 from the transformed gas entrance up through the transformed gas exit of the CO eliminator 11, and the quantity of a selective oxidation catalyst at the transformed gas entrance is decreased but it is increased toward the transformed gas exit. Moreover, the hydrogen generator for the fuel cell 1B is constituted the same as the hydrogen generator for the fuel cell 1A of the present invention shown in FIG. 3 except that a not-illustrated blower is set in a vessel 12, cooling air is supplied thereinto from a cooling air entrance 17 and sent to a first spatial portion 13 and a second spatial portion 14 to cool a CO transformer 9 and the CO eliminator 11 and to control temperature thereof so as to be kept respectively at an optimum temperature.

There is an advantage that a transformed gas flow is uniformed in accordance with a throttling efficiency at the transformed gas entrance of the CO eliminator 11. Moreover, it is possible to reduce a calorific value due to an exothermic reaction nearby the transformed gas entrance of the CO eliminator 11, control a reaction heat quantity, prevent a runaway reaction from occurring nearby the transformed gas entrance, and accurately control a reaction temperature in the CO eliminator 11 at an optimum temperature (approximately 100 to 200° C.).

By supplying air to the first spatial portion 13 and the second spatial portion 14 to control temperature, it is possible to eliminate the heat caused by exothermic reactions in the CO transformer 9 and CO eliminator 11 and accurately control them at an optimum temperature respectively.

(4) Fourth Embodiment

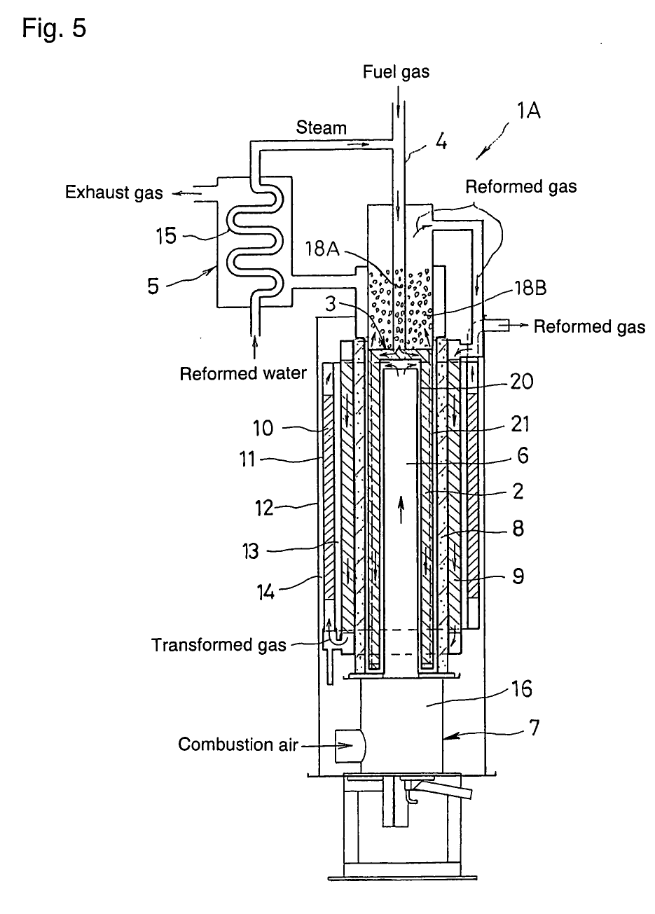

FIG. 5 is a cross-sectional explanatory view showing another embodiment of the hydrogen generator for the fuel cell of the present invention.

In FIG. 5, components provided with numerals same as those shown in FIGS. 1 to 4 show the same components shown in FIGS. 1 to 4 but duplicate explanation is omitted.

As shown in FIG. 5, hydrogen generator for a fuel cell 1C of the present invention is the same as the hydrogen generator for the fuel cell 1A of the present invention shown in FIG. 3 except that a heat transfer accelerating material or a heat storing material 18A is set at a fuel gas entrance led to a reforming pipe 3, and a heat transfer accelerating material or a heat storing material 18B is set at a reformed gas exit from the reforming pipe 3.

Temperatures nearby the fuel gas entrance and the reformed gas exit of the reforming pipe 3 become approximately 200 to 300° C. under the operating condition of the hydrogen generator for the fuel cell 1C of the present invention. Therefore, by setting a heat transfer accelerating material or the heat storing material 18A (reticulate or granular alumina, stainless steel, and so on) at the fuel gas entrance to the reforming pipe 3, the temperature of the material also becomes approximately 200 to 300° C. and thereby, it is possible to preheat the temperature of a fuel gas or steam contacting with the heat transfer accelerating material or the heat storing material 18A at 200 to 300° C. Moreover, also in the case of the heat transfer accelerating material or the heat storing material (reticulate or granular alumina, stainless steel, and so on) 18B set to the exit of the reformer 3, it is possible to set the temperature of a reformed gas contacting with the material at approximately 200 to 300° C. Therefore, it is unnecessary to set a heat exchanger externally at the exit of the reformer 3 and it is possible to accurately control a reaction temperature in a CO transformer 9 at an optimum temperature by recovering excess heat and effectively using it.

Because the above embodiments are described to explain the present invention but inventions described in claims are not restricted or scopes of the inventions are not reduced. Moreover, configurations of different portions of the present invention are not restricted to those of the above embodiments but it is possible to variously modify the configurations in the technical ranges of claims.

In the case of the hydrogen generator for the fuel cell of claim 1 of the present invention, a reforming pipe in which a catalyst layer is formed by filling a reforming catalyst obtained by making a fuel containing an organic compound having hydrogen atoms react with water to reform the fuel and water into a hydrogen-rich gas between an erect pipe and a polygonal or wavelike outer pipe surrounding the erect pipe and an outermost pipe in which vertexes of the polygonal or wavelike outer pipe are inscribed to the contour of the reforming pipe are set to form a passage of the reformed gas between the outer pipe and the outermost pipe. Therefore, by setting a combustion pipe to the inside of the inner pipe of the reforming pipe, supplying a heat quantity necessary for a reforming reaction to the catalyst layer by burning a combustion fuel in the combustion pipe and passing a reformed gas through the passage of the reformed gas formed between the outer pipe and outermost pipe while supplying exhaust gas to the inside of the inner pipe of the reforming pipe and the outer circumference of the outermost pipe, the heat of the exhaust gas is conducted from the outermost pipe side to the outer pipe side through contact points between vertexes of the polygonal or wavelike outer pipe because the vertexes are inscribed to the outermost pipe and the reforming catalyst in the reforming pipe is heated by exhaust gas from the inside of the inner pipe and moreover heated also from the outer pipe side by the exhaust gas. Therefore, it is possible to prevent heat from being taken by the reformed gas and a remarkable advantage that the heat efficiency is improved is obtained.

The hydrogen generator for the fuel cell of claim 2 of the present invention uses the hydrogen generator for the fuel cell of claim 1 which comprises the reforming pipe, a fuel supplying part for supplying the fuel to the reforming pipe, a water supplying part for supplying the water to the reforming pipe, heating means for supplying a heat quantity necessary for the reforming reaction by burning a combustion fuel in a combustion pipe set to the inside of the inner pipe of the reforming pipe, the outermost pipe in which vertexes of the polygonal or wavelike pipe are inscribed to the contour of the reforming pipe, heat insulating means for insulating the heat released from the reforming pipe at the outer periphery of the outermost pipe, a CO transformer for making carbon monoxide contained in a reformed gas flowing out from the reforming pipe react with water and thereby transforming the carbon monoxide and water into carbon dioxide, a CO eliminator having an selective oxidation catalyst for making carbon monoxide contained in a transformed gas flowing out from the CO transformer react with air or oxygen to generate carbon dioxide, and a vessel for housing the above components, in which the combustion pipe, the reforming pipe, the outermost pipe, the heat insulating means, the CO transformer, a first spatial portion, the CO eliminator, a second spatial portion, and the vessel are cocentrically arranged in order. Therefore, the hydrogen generator for the fuel cell of claim 2 of the present invention provides the same advantages as the hydrogen generator for the fuel cell of claim 1. Moreover, the generator of claim 2 provides more remarkable advantages that a simple configuration is realized by setting the combustion pipe of the heating means for supplying a heat quantity necessary for a reforming reaction by burning a combustion fuel at the center, setting the reforming pipe around the combustion pipe, setting the outermost pipe around the reforming pipe, and setting the heat insulating means at the outside of the outermost pipe, setting the CO transformer at the outside of the heat insulating means, setting the CO eliminator at the outside of the CO transformer, housing these components in one vessel to unite them into one body, and disusing the heat exchanger at the outlet of the reformer, the configuration can be downsized, each reactor can be accurately controlled by recovering excess heat from each reactor and effectively using the heat and the heat efficiency is improved.

The hydrogen generator for the fuel cell of claim 3 of the present invention uses the hydrogen generator for the fuel cell of claim 2 in which the heat insulating means is a heat insulating material and a quality and a thickness of the heat insulating material are selected so as to be able to control the surface temperature of the heat insulating material at 200 to 300° C. Therefore, a more remarkable advantage is obtained that it is possible to accurately control a reaction temperature in the CO transformer at an optimum temperature of 200 to 300° C.

The hydrogen generator for the fuel cell of claim 4 of the present invention uses the hydrogen generator for the fuel cell of claim 2 or 3 in which the heat insulating means is a mirror-surface heat insulating member and a quality and a surface finish state of the mirror-surface heat insulating member are selected so as to be able to control the inside temperature of the CO transformer at 200 to 300° C. Therefore, it is possible to accurately control a reaction temperature in the CO transformer at approximately 200 to 300° C. and a more remarkable advantage can be obtained that the generator can be further downsized.

The hydrogen generator for the fuel cell of claim 5 of the present invention uses the hydrogen generator for the fuel cell of claim 2 in which the heat insulating means is a vacuum space and a thickness and a vacuum degree of the vacuum space are selected so as to be able to control the inside temperature of the CO transformer at 200 to 300° C. Therefore, it is possible to accurately control a reaction temperature in the CO transformer at an optimum temperature of approximately 200 to 300° C. and moreover, a more remarkable advantage can be obtained that it is possible to further downsize the hydrogen generator for the fuel cell by using the heat insulating material and the mirror-surface heat insulating member together.

The hydrogen generator for the fuel cell of claim 6 of the present invention uses the hydrogen generator for the fuel cell of any one of claims 2 to 5 in which because a heat transfer accelerating material or heat storing material is set to the reformer outlet, the temperature of the heat transfer accelerating material or heat storing material set to the outlet of the reformer becomes approximately 200 to 300° C. and thereby, more remarkable advantages can be obtained that it is possible to set the temperature of a reformed gas contacting with the heat transfer accelerating material or the heat storing material at approximately 200 to 300° C. and accurately control a reaction temperature in the CO transformer at an optimum temperature by recovering excess heat and effectively using it.

The hydrogen generator for the fuel cell of claim 7 of the present invention uses the hydrogen generator for the fuel cell of any one of claims 2 to 6 in which a gradient is formed on the external wall of the vessel in the range from the transformed gas inlet to the transformed gas outlet of the CO eliminator to change the selective oxidation catalyst quantity in the range from the transformed gas inlet to the transformed gas outlet. Therefore, more remarkable advantages can be obtained that it is possible to reduce the calorific value due to an exothermic reaction nearby the transformed gas inlet of the CO eliminator, prevent a runaway reaction from occurring, and accurately control a reaction temperature in the CO eliminator at an optimum temperature (approximately 100 to 200° C.).

The hydrogen generator for the fuel cell of claim 8 of the present invention uses the hydrogen generator for the fuel cell of any one of claims 2 to 7 in which because a blower is set in the vessel and air is supplied to the first spatial portion and second spatial portion to control temperature, a more remarkable advantage is obtained that the temperature due to exothermic reactions in a CO transformer and CO eliminator is eliminated and thereby, it is possible to accurately control the CO transformer and CO eliminator at an optimum temperature respectively.

The hydrogen generator for the fuel cell of claim 9 of the present invention uses the hydrogen generator for the fuel cell of any one of claims 2 to 8 in which because a blower is set in the vessel to control the temperature of the selective oxidation catalyst layer at the transformed gas inlet side of the CO eliminator at 100 to 200° C., a more remarkable advantage is obtained that a heat quantity due to an exothermic reaction nearby the transformed gas inlet of the CO eliminator is reduced and a runaway reaction is prevented from occurring.

What is claimed is:

1. A hydrogen generator for a fuel cell comprising;
a reforming pipe comprising;
an erect inner pipe;
an outer pipe surrounding said erect inner pipe of which cross section is polygonal or wavelike; and
a catalyst layer formed between the erect inner pipe and the outer pipe, with said catalytic layer being filled with a reforming catalyst to make a fuel containing an organic compound having hydrogen atoms react with water to reform into a hydrogen-rich gas;
an outermost pipe surrounding and inscribed by the outer pipe in each vertexes of the contour thereof; and
a passage of the reformed gas formed between the outer pipe and the outermost pipe.

2. The hydrogen generator for the fuel cell according to claim 1, further comprising;
a fuel supplying part for supplying the fuel to the reforming pipe;
a water supplying part for supplying the water to the reforming pipe;
a heating means for supplying a heat quantity necessary for a reforming reaction by burning a combustion fuel in a combustion pipe set inside of the erect inner pipe of the reforming pipe;
a heat insulating means for insulating the heat released from the reforming pipe at the outer periphery of the outermost pipe;
a CO transformer for making carbon monoxide contained in a reformed gas flowing out from the reforming pipe react with water and thereby to transform carbon monoxide and water into carbon dioxide;
a CO eliminator having an selective oxidation catalyst for making carbon monoxide contained in a transformed gas flowing out from the CO transformer react with air or oxygen to generate carbon dioxide; and
a vessel for housing the above components,
wherein the combustion pipe, the reforming pipe, the outermost pipe, the heat insulating means, the CO transformer, a first spatial portion, the CO eliminator, a second spatial portion, and the vessel are arranged in a concentrical circular way in order from the inside.

3. The hydrogen generator for the fuel cell according to claim 2, wherein the heat insulating means is a heat insulting material, and a quality and a thickness of the heat insulating material are selected so as to be able to control the surface temperature of the heat insulating material at 200 to 300° C.

4. The hydrogen generator for the fuel cell according to claim 2 or 3, wherein the heat insulating means is a mirror-surface heat insulating member and a quality, a thickness, and a surface finish state of the mirror-surface heat insulating member are selected so as to be able to control the inside temperature of the CO transformer at 200 to 300° C.

5. The hydrogen generator for the fuel cell according to claim 2, wherein the heat insulating means is a vacuum space, and a thickness and a vacuum degree of the vacuum space are selected so as to be able to control the inside temperature of the CO transformer at 200 to 300° C.

6. The hydrogen generator for the fuel cell according to any one of claims 2 to 5, wherein a heat transfer accelerating material or a heat storing material is set to the outlet of the reformer.

7. The hydrogen generator for the fuel cell according to any one of claims 2 to 6, wherein the external wall of the vessel is sloped in the range from the inlet up to the outlet of the transformed gas of the CO eliminator to change the quantity of the selective oxidation catalyst across the diameter from the inlet up to the outlet of the transformed gas.

8. The hydrogen generator for the fuel cell according to any one of claims 2 to 7, wherein a blower is set in the vessel and air is supplied to the first spatial portion and the second spatial portion to control the temperature.

9. The hydrogen generator for the fuel cell according to any one of claims 2 to 8, wherein a blower is set in the vessel to control the temperature of the selective oxidation catalyst layer at the transformed-gas inlet side of the CO eliminator to 100 to 200° C.
